(19) United States
(12) Patent Application Publication
(10) Pub. No.: US 2024/0220857 A1
(43) Pub. Date: Jul. 4, 2024

(54) SYSTEM AND METHOD FOR TRAINING AGENT BASED ON TRANSFER TRAINING

(71) Applicant: ELECTRONICS AND TELECOMMUNICATIONS RESEARCH INSTITUTE, Daejeon (KR)

(72) Inventors: Sooyoung Jang, Daejeon (KR); Sang Yeoun LEE, Daejeon (KR); Ji Hun JEON, Daejeon (KR)

(21) Appl. No.: 18/229,283

(22) Filed: Aug. 2, 2023

(30) Foreign Application Priority Data
Dec. 29, 2022 (KR) 10-2022-0188249

(51) Int. Cl. G06N 20/00

(52) U.S. Cl. CPC G06N 20/00

(57) ABSTRACT

An agent training method based on transfer training is provided. The method includes preparing an agent pre-trained in a first environmental condition (hereinafter referred to as source agent), obtaining training data for training of an agent to be trained in a second environmental condition (hereinafter referred to as target agent) different from the first environmental condition by using the source agent, pre-training the target agent based on the training data, and performing deep reinforcement training-based training on the pre-trained target agent in the second environmental condition.

### BACKGROUND

### 1. Technical Field

The present disclosure relates to a system and method for training an agent training based on transfer training.

### 2. Description of Related Art

Recently, different elemental technologies for constructing autonomous robot control systems are rapidly developing, and researches on deep reinforcement training technologies for autonomous robot controls are being actively conducted.

However, since there are actually a variety of fields to which autonomous robot control systems are applicable, it is time-consuming and thus expensive to optimize deep networks for each field.

### SUMMARY

An object to be achieved by the present disclosure is to provide a system and method for training an agent based on transfer training, which enables agent training with a significantly shortened time, compared to the time required to train the agent from the beginning in a changed situation, by applying a training method based on transfer training, in which the knowledge of the agent trained in an existing situation is transferred to a new agent to be trained corresponding to the changed situation.

However, the object to be achieved by the present disclosure is not limited to the foregoing, and other objects may exist.

A method for training an agent based on transfer training according to the first aspect of the present disclosure for achieving the aforementioned object includes preparing an agent pre-trained in a first environmental condition (hereinafter referred to as source agent), obtaining training data for training of an agent to be trained in a second environmental condition (hereinafter referred to as target agent) different from the first environmental condition by using the source agent, pre-training the target agent based on the training data, and performing deep reinforcement training-based training on the pre-trained target agent in the second environmental condition.

Additionally, a system for training an agent based on transfer training according to the second aspect of the present disclosure includes a memory storing a program for training an agent pre-trained in a first environmental condition (hereinafter referred to as a source agent) and an agent to be trained (hereinafter referred to as a target agent) based on the source agent in a second environmental condition different from the first environmental condition, and a processor which, while executing the program stored in the memory, obtains training data for training of the target agent, pre-trains the target agent based on the training data, and then performs deep reinforcement training-based training in the second environmental condition with respect to the pre-trained target agent.

A computer program according to another aspect of the present disclosure for achieving the aforementioned object is combined with a computer executes the method for training an agent based on transfer training, and is stored in a computer-readable recording medium.

Other specific details of the disclosure are included in the detailed description and drawings.

In the real environment, there are various problems to be solved, and thus it has been considered problematic in terms of effectiveness to train an agent separately from the beginning for each problem of the real environment because such approach requires a lot of training time and computing resources. However, according to an embodiment of the present disclosure, it is possible to facilitate the practical application of a deep reinforcement training-based agent by applying a method in which knowledge of an agent trained in an existing problem is transferred to a new agent.

In particular, an embodiment of the present disclosure can quickly train an agent for solving a new problem, and through this, it is possible to expect the very high applicability thereof to the real environment in which various problems, that is, various situations exist.

Further, when an embodiment of the present disclosure is applied to an autonomous robot control system, a new agent can be quickly trained even if the sensor mounted on the robot or the robot's mission changes, thereby making it possible to expand the application field of autonomous robot control technology. In addition, it can facilitate the practical application of the autonomous robot control technology. That is, an embodiment of the present disclosure enables rapid adjustment to a situational change, and so it is possible to expect a great application advantage in a real environment in which various situations exist.

Effects of this disclosure are not limited to the effects mentioned above, and other effects not mentioned above can be clearly appreciated by those skilled in the art from the description below.

### BRIEF DESCRIPTION OF THE DRAWINGS

FIG. 1 is a diagram for explaining the agent training system (100) according to an embodiment of the present disclosure.

FIG. 2 is a flowchart of an agent training method based on transfer training according to an embodiment of the present disclosure.

FIG. 3 shows an algorithm representing the overall flow of an agent training method based on transfer training according to an embodiment of the present disclosure.

FIG. 4 shows a flowchart for explaining a process of obtaining training data in an embodiment of the present disclosure.

FIG. 5 shows an algorithm representing a process of obtaining training data in an embodiment of the present disclosure.

FIG. 6 is a flowchart for explaining a pre-training process in one embodiment of the present disclosure.

FIG. 7 shows an algorithm representing a pre-training process in one embodiment of the present disclosure.

FIG. 8 shows an algorithm representing a deep reinforcement training process in one embodiment of the present disclosure.

FIG. 9 shows the required training time according to the prior art.

FIGS. 10A to 10C show required training time in an embodiment of the present disclosure.

### DETAILED DESCRIPTION

Advantages and characteristics of the disclosure, and methods of achieving them will become apparent with reference to the embodiments described below in detail in conjunction with the accompanying drawings. However, the present disclosure is not limited to the embodiments disclosed below, but will be implemented in a variety of different forms, and the present embodiments are only provided so that the present disclosure is complete, and to fully inform those of ordinary skill in the art to which the present disclosure pertains of the scope of the disclosure, and the present disclosure is defined only by the scope of the claims.

As used herein, the terms are for the purpose of describing the embodiments, and are not intended to limit the present disclosure. Herein, terms in the singular form also relate to the plural form unless specifically stated otherwise in the context. As used herein, the terms “comprises” and/or “comprising” do not preclude the presence or addition of at least one component other than the recited elements. Like reference numerals refer to like elements throughout the specification, and as used herein the expression “and/or” includes any and all combinations of one or more of the listed elements. Although the terms “first”, “second”, etc. may be used herein to describe various elements, these elements are not limited by these terms, of course. These terms are only used to distinguish one element from another. Accordingly, it goes without saying that the first element mentioned below may also be the second element within the technical spirit of the present disclosure.

Unless otherwise defined, all terms (including technical and scientific terms) used herein have the same meaning as commonly understood by those skilled in the art to which this disclosure pertains. In addition, terms defined in commonly used dictionaries are not to be interpreted ideally or excessively unless explicitly specifically defined.

Hereinafter, the background from which the present disclosure was conceived will be described in order to aid the understanding of those skilled in the art, and then the present disclosure will be described in detail.

Recently, hardware and software elemental technologies for constructing autonomous robot control systems are rapidly developing.

In terms of hardware, sensor technology is being developed in all respects, such as high performance, miniaturization, light weight, low power consumption, and low cost of sensors such as RGB-D, Lidar, and the like which are responsible for recognition, and which are one of the essential elements for autonomous robot control. Further, with the advent of Nvidia Jetson, the performance of an embedded board that will be responsible for computing power for autonomous robot control is rapidly increasing.

In terms of software, researches on artificial intelligence technologies, such as computer vision for extracting meaningful information from surrounding situations recognized through sensors, reinforcement training that can autonomously generate control commands based on natural language processing and perceived surrounding situations, and the like, are performed explosively, and artificial intelligence technology is widely applied across the all industries.

The development of these elemental technologies accelerates the development of autonomous robot control systems, and accordingly, the application fields are continuously expanding. In particular, since autonomous robot control technology can help to achieve the purpose of robot control without the need for direct or remote control by a human, fields such as searching for victims in disaster environments, detecting forest fires, and establishing emergency communication networks are also gaining popularity as application fields.

Among various artificial intelligence technologies for autonomous robot control, deep reinforcement training is a training method in which the policy function, which is the control intelligence of the robot agent (hereinafter referred to as agent) that determines the action of the agent, is approximated with a deep network, and then an approximated network is optimized suitable to the control purpose of the agent. In general, the deep reinforcement training is a method in which an agent trains an optimal policy function based on experience data collected through various trials and errors in a given environment, and the deep reinforcement training allows the agent to learn control rules on their own without the need for humans to specify control rules, but has the disadvantage of requiring a lot of time and computing power for training.

In particular, whenever the situation changes, the agent must be trained in the changed situation. In this case, a lot of time and computing power are required, which is one of the main reasons that make it difficult to apply deep reinforcement training-based agents in practice. At this time, examples of the situation change include a change in sensor type, a change in sensor resolution, a change in sensor preprocessing technique, and a change in control purpose (i.e., mission).

Meanwhile, technologies such as curriculum training, imitation training, and offline reinforcement training are being studied to increase the agent's training speed, but these technologies assume that the situation does not change. In other words, their main purpose is directed to how to train an agent when the situation does not change.

Here, the curriculum training imitates training scheme of a human, and is a training method of providing an agent with a curriculum to achieve a final goal. The imitation training is to provide the agent with how an expert solves the goal, and to allow the agent to follow and train it. At this time, it is assumed that the expert and the training target agent solve the same problem. Additionally, the off-line reinforcement training is a method of accelerating agent training by obtaining data from a trained agent and providing the data to the training target agent.

Unlike the prior art, an embodiment of the present disclosure proposes a training method based on transfer training that uses an agent trained in an existing situation when training an agent suitable for a changed situation. Through this, an embodiment of the present disclosure has an advantage in that it is possible to train an agent with a significantly shortened time compared to the time required when training an agent from the beginning in a changed situation.

In the real environment, there are various problems to be solved, and thus it has been considered problematic in terms of effectiveness to train an agent separately from the beginning for each problem of the real environment because such approach requires a lot of training time and computing resources. However, according to an embodiment of the present disclosure, it is possible to facilitate the practical application of a deep reinforcement training-based agent by applying a method in which knowledge of an agent trained in an existing problem is transferred to a new agent.

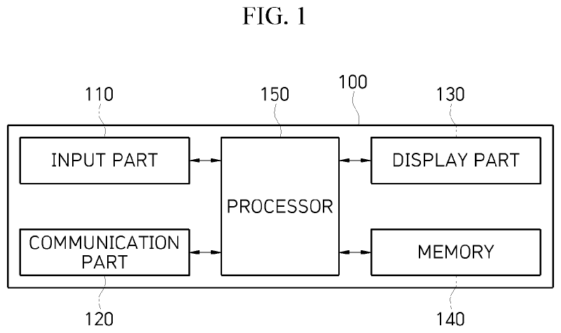

Hereinafter, with reference to FIG. 1, a transfer training-based agent training system 100 (hereinafter referred to as agent training system) according to an embodiment of the present disclosure will be described.

FIG. 1 is a diagram for explaining the agent training system 100 according to an embodiment of the present disclosure.

The agent training system 100 according to an embodiment of the present disclosure includes an input part 110, a communication part 120, a display part 130, a memory 140, and a processor 150.

The input part 110 generates input data in response to an input of the agent training system 100. In this regard, the input may be a user input, and the user input may include a user input related to data that the agent training system 100 is to process. The input part 110 includes at least one input means. The input part 110 may include a keyboard, a key pad, a dome switch, a touch panel, a touch key, a mouse, a menu button, or the like.

The communication part 120 transceivers data between internal components, or communicates with an external device such as an external server or the like. That is, the communication part 120 may receive an observation value of an agent applied to an existing environment or an observation value in an environment to which a training target agent (hereinafter referred to as a target agent) is applied, or may transceive other necessary data. This communication part 120 may include both a wired communication module and a wireless communication module. The wired communication module may be implemented as a power line communication device, a telephone line communication device, cable home (MoCA), Ethernet, IEEE1294, an integrated wired home network, and an RS-485 control device. Additionally, the wireless communication module may be constituted with a module for implementing a function of wireless LAN (WLAN), Bluetooth, HDR WPAN, UWB, ZigBee, Impulse Radio, 60 GHz WPAN, Binary-CDMA, wireless USB technology and wireless HDMI technology, other 5th generation communication (5G), long term evolution-advanced (LTE-A), long term evolution (LTE), wireless fidelity (Wi-Fi), or the like.

The display part 130 displays display data according to the operation of the agent training system 100. The display part 130 includes a liquid crystal display (LCD), a light emitting diode (LED) display, an organic LED (OLED) display, a micro electro mechanical system (MEMS) display, or an electronic paper display. The display part 130 may be combined with the input part 110 so that they may be implemented as a touch screen.

The memory 140 stores a program for training an agent pre-trained in a first environmental condition (hereinafter referred to as source agent) and an agent to be trained (hereinafter referred to as target agent) based on the source agent in a second environmental condition different from the first environmental condition. Here, the memory 140 collectively refers to a volatile storage device and a non-volatile storage device which continuously retains stored information even when power is not supplied. For example, the memory 140 may include a compact flash (CF) card, a secure digital (SD) card, a memory stick, a NAND flash memory such as a solid-state drive (SSD), a micro SD card or the like, a magnetic computer storage device such as a hard disk drive (HDD) or the like, an optical disc drive such as a CD-ROM, a DVD-ROM or the like, or the like.

The processor 150 may execute software such as a program to control at least one other component (e.g., hardware or software component) of the agent training system 100, and may perform various data processings or calculations.

As the processor executes the program, it constructs training data and performs pre-training and deep reinforcement training.

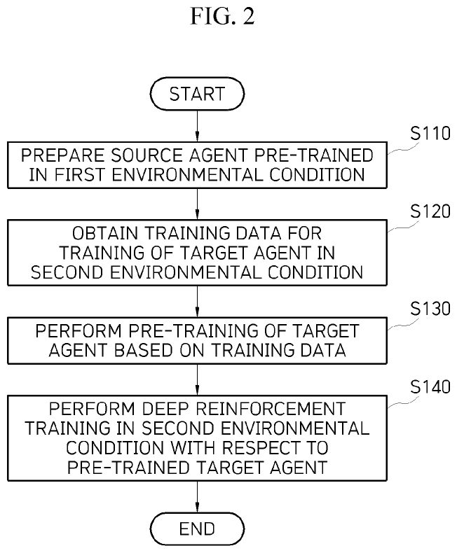

Hereinafter, an agent training method based on transfer training performed by the agent training system 100 according to an embodiment of the present disclosure will be described with reference to FIGS. 2 to 8.

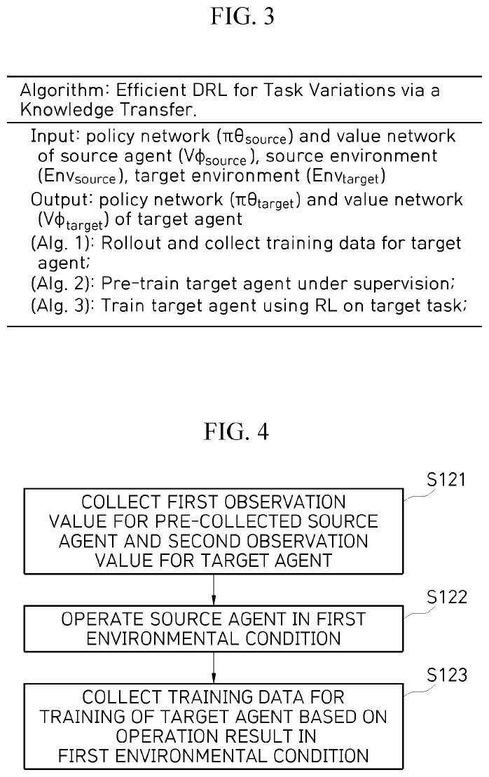

FIG. 2 is a flowchart of an agent training method based on transfer training according to an embodiment of the present disclosure. FIG. 3 shows an algorithm representing the overall flow of an agent training method based on transfer training according to an embodiment of the present disclosure.

An embodiment of the present disclosure includes and performs preparing a source agent pre-trained in a first environmental condition (S110), obtaining training data for training of a target agent to be trained in a second environmental condition different from the first environmental condition by using the source agent (S120), pre-training the target agent based on the training data (S130), and performing deep reinforcement training-based training on the pre-trained target agent in the second environmental condition (S140). In the present disclosure, an existing problem (first environmental condition) is represented as a source, and a new problem (second environmental condition) is represented as a target.

In an embodiment of the present disclosure, a deep reinforcement training-based agent is constructed with a policy network (π_{θ}) constructed with a weight θ and a value network (V_{ϕ}) constructed with a weight ϕ. The policy network is a network that determines the optimal action value α for an observation value o, and the agent acts according to the optimal action value. The value network is a network required for deep reinforcement training-based agent training, and represents a value v for the current state.

As an example, an object of the agent training method based on transfer training according to an embodiment of the present disclosure is to perform deep reinforcement training so that an agent trained in the existing problem (first environmental condition) of finding a target with a drone while avoiding obstacles using a depth camera is applicable to a new problem (second environmental condition) of finding a target with a drone while avoiding obstacles using an RGB-D camera.

In the conventional method, since the input for the agent was changed from the depth image to the RGB-D image, the agent had to train again from the beginning, whereas according to an embodiment of the present disclosure, it is possible to train the agent operating based on the RGB-D camera quickly by using the agent trained based on the depth camera.

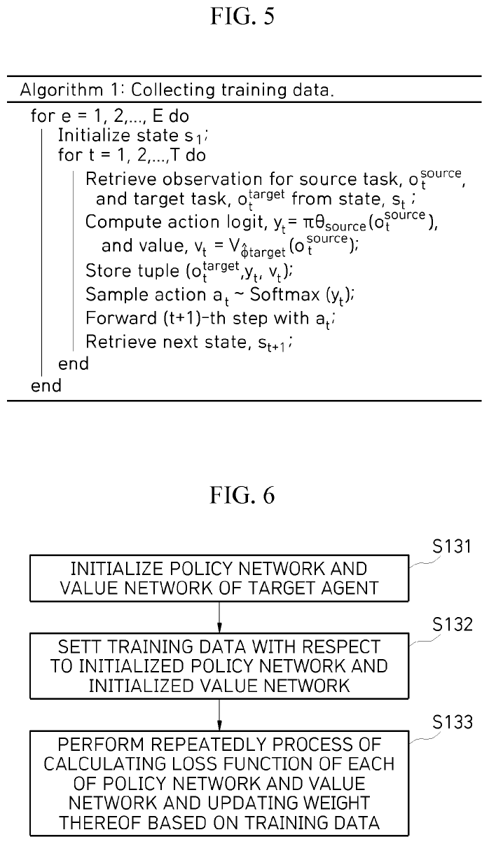

FIG. 4 shows a flowchart for explaining a process of obtaining training data in an embodiment of the present disclosure. FIG. 5 shows an algorithm representing a process of obtaining training data in an embodiment of the present disclosure.

In an embodiment of the present disclosure, when the preparation of the source agent is completed, training data for the training of the target agent is obtained by using the source agent (S120).

At this time, according to an embodiment of the present disclosure, by modifying the environmental conditions with which the agent interacts, a state value (s) including a second observation value (o^{target}) for the target agent in addition to a first observation value (o^{source}) for the source agent pre-collected with respect to the first environmental condition is returned (S121).

For example, in the case of a depth camera-based method, only depth camera information is returned as a first observation value, but this is modified so that RGB-D information is also returned.

Then, the source agent is operated in the first environmental condition (S122). That is, the source agent uses o^{source} in the first environmental condition to solve the existing problem which the source agent trained.

Next, training data (o^{target}, y, v) for training of the target agent is collected based on the operation result in the first environmental condition (S123).

Here, y represents the optimal action value for the first observation in the policy network, and v represents the value of the current state for the first observation value in the value network. In an embodiment of the present disclosure, the optimal action value and the value may be expressed as function values (yₜ, Vₜ) according to time.

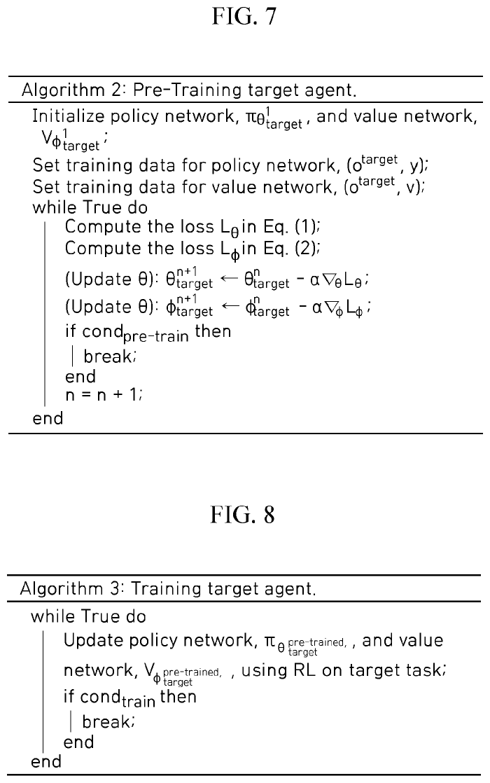

FIG. 6 is a flowchart for explaining a pre-training process in one embodiment of the present disclosure. FIG. 7 shows an algorithm representing a pre-training process in one embodiment of the present disclosure.

In an embodiment of the present disclosure, when the construction of the training data is completed, the target agent is trained based on the training data (S130).

To this end, an embodiment of the present disclosure initializes the policy network (π_{θ}_{_{target}}_{¹}) and the value network (V_{ϕ}_{_{target}}_{¹}) of the target agent (S131).

Next, training data for supervised training-based training is set for the initialized policy network and the initialized value network (S132). At this time, the training data for the policy network is (o^{target}, y), and the training data for the value network is (o^{target}, v).

Then, based on the training data, the training of the target agent is performed by repeatedly performing the process of calculating the loss function of each of the policy network and the value network and updating the weight thereof (S133).

In this regard, the loss function of the policy network may be expressed as Equation 1, and the loss function of the value network may be expressed as Equation 2.

$${ℒ}_{θ} = \frac{1}{\vert {O}^{target} \vert} {\sum }_{{o}^{t a r g e t} ∈ {O}^{t a r g e t}} {( {π}_{θ} ( {o}^{target} ) - y )}^{2} \qquad [ Equation 1 ]$$

$${ℒ}_{ϕ} = \frac{1}{\vert {O}^{target} \vert} {\sum }_{{o}^{t a r get} ∈ {O}^{t a r g e t}} {( {V}_{ϕ} ( {o}^{target} ) - v )}^{2} \qquad [ Equation 2 ]$$

Meanwhile, the pre-training process may be repeatedly performed until the training stopping condition including at least one of the early stopping condition according to the degree of reduction of each loss function value and the predefined iteration number condition is satisfied.

FIG. 8 shows an algorithm representing a deep reinforcement training process in one embodiment of the present disclosure.

As an embodiment of the present disclosure, the deep reinforcement training is performed in a second environmental condition with respect to a pre-trained target agent (S140).

At this time, in the present disclosure, the target agent (π_{θ}_{_{target}}_{^{pre-trained}}, v_{φ}_{_{target}}_{^{pre-trained}}) may be trained based on the deep reinforcement training until a predetermined training condition (condₜᵣₐᵢₙ) is satisfied. For example, the predetermined training condition may include at least one of a problem solving success rate corresponding to the second environmental condition and the predefined number of iterations.

Meanwhile, steps S110 to S140 in the above description may be further divided into additional steps or combined into fewer steps according to an embodiment of the present disclosure. Also, some steps may be dispensable as circumstances demand, and the order of steps may be changed. Additionally, even though the content is omitted, the contents described in FIG. 1 and the contents described in FIGS. 2 to 8 may be mutually applied.

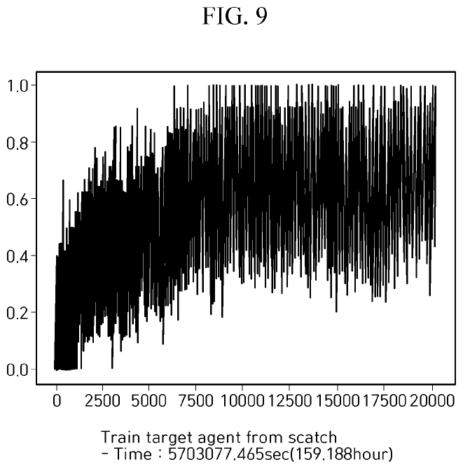

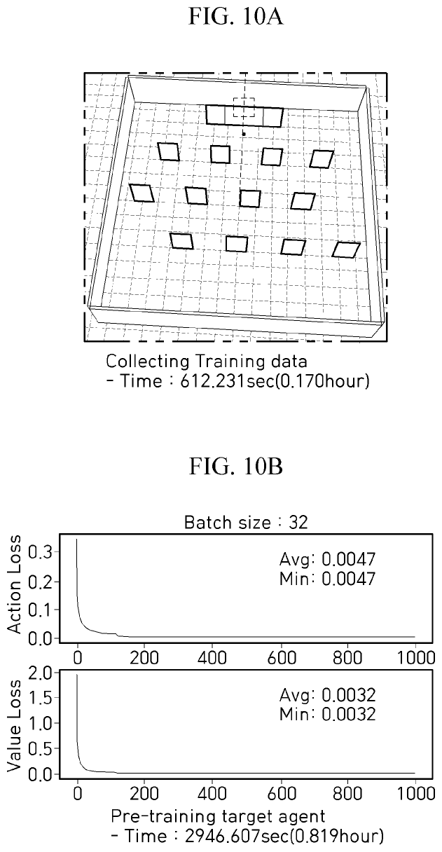

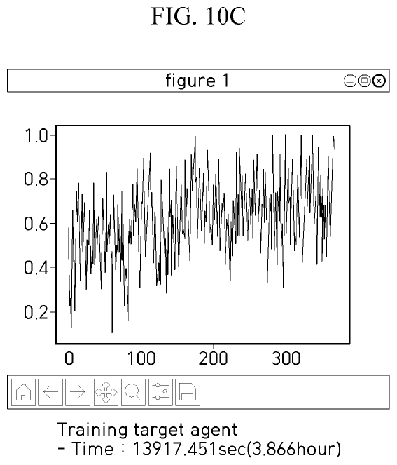

FIG. 9 shows the required training time according to the prior art. FIGS. 10A to 10C show required training time in an embodiment of the present disclosure.

Referring to FIG. 9, in the prior art, in order to solve a new problem, a target agent must be trained based on reinforcement training from the beginning, and in this case, a total of 159.188 hours were spent on the training.

Referring to FIGS. 10A to 10C, it can be confirmed that a total of 4.855 hours are spent for the target agent training by applying an embodiment of the present disclosure, which reduces the training time by about 96.95% compared to the prior art.

The agent training method based on transfer training according to an embodiment of the present disclosure described above may be implemented as a program (or application) to be executed in combination with a computer, which is hardware, and may be stored in a medium.

The above-mentioned program may include a code coded in a computer language, such as C, C++, JAVA, Ruby, machine language or the like, that can be read by a processor (CPU) of the computer through a device interface of the computer in order for the computer to read the program and execute the methods implemented in the program. This code may include functional codes related to functions or the like defining necessary capabilities for executing the methods, and may include execution procedure-related control codes necessary for the computer's processor to execute the capabilities according to a predetermined procedure. In addition, this code may further include a code related to memory reference as to which location (address) of the computer's internal or external memory the additional information or medium necessary for the processor of the computer to execute the capabilities should be referenced from. Further, if the processor of the computer needs to communicate with any other remote computer or server in order to execute the capabilities, the code may further include a communication-related code as to how to communicate with any other remote computer or server using the communication module of the computer, what kind of information or medium should be sent and received during the communication, and the like.

The aforementioned storage medium is not a medium that stores data for a short moment, such as a register, cache, memory or the like, but a medium that stores data semi-permanently and is readable by a device. Specifically, examples of the aforementioned storage medium include, but are not limited to, ROM, RAM, CD-ROM, magnetic tape, floppy disk, optical data storage device, and the like. That is, the aforementioned program may be stored in various recording media on various servers accessible by the aforementioned computer, or in various recording media on the user's computer. Furthermore, the aforementioned medium may be distributed to computer systems connected by a network, and computer readable codes may be stored in a distributed manner.

The aforementioned description of the present disclosure is only for illustration purposes, and a person having ordinary skill in the art to which the present disclosure pertains may understand that it can be easily modified into other specific configuration without changing the technical idea or essential features of the present disclosure. Accordingly, it should be understood that the embodiments described above are illustrative in all respects and not restrictive. For example, the respective components described as a singular form may be implemented in a distributed form, and the respective components described as a distributed form may be implemented in a combined form.

The scope of the disclosure is defined by the following claims rather than the detailed description, and all changed or modified forms derived from the meaning and scope of the claims and equivalents thereto should be interpreted as being included in the scope of the disclosure.

What is claimed is:

1. A method for training an agent based on transfer training, which is a method performed by a computer, the method comprising:
preparing an agent pre-trained in a first environmental condition (hereinafter referred to as source agent);
obtaining training data for training of an agent to be trained in a second environmental condition (hereinafter referred to as target agent) different from the first environmental condition by using the source agent;
pre-training the target agent based on the training data; and
performing deep reinforcement training-based training on the pre-trained target agent in the second environmental condition.

2. The method for training an agent based on transfer training of claim 1, wherein the obtaining of the training data for training of the target agent in the second environmental condition different from the first environmental condition by using the source agent includes:
collecting a second observation value for the target agent in addition to a first observation value for a source agent pre-collected with respect to the first environmental condition;
operating the source agent in the first environmental condition; and
collecting training data for training of the target agent based on an operation result in the first environmental condition.

3. The method for training an agent based on transfer training of claim 2, wherein the operating of the source agent in the first environmental condition includes:
obtaining an optimal action value for the first observation value in a policy network; and
obtaining a value of a current state for the first observation value in a value network.

4. The method for training an agent based on transfer training of claim 3, wherein the collecting of the training data for training of the target agent based on the operation result in the first environmental condition includes collecting an optimal action value and a value for the first observation value and the second observation value as the training data.

5. The method for training an agent based on transfer training of claim 1, wherein the pre-training of the target agent based on the training data includes:
initializing a policy network and a value network of the target agent;
setting the training data for supervised training-based training with respect to the initialized policy network and the initialized value network; and
training the target agent by performing repeatedly a process of calculating a loss function of each of a policy network and a value network and updating a weight thereof based on the training data.

6. The method for training an agent based on transfer training of claim 5, wherein the training of the target agent by performing repeatedly a process of calculating a loss function of each of the policy network and the value network and updating a weight thereof based on the training data includes performing the training repeatedly until a training stopping condition including at least one of a training early stopping condition according to a degree of reduction of the respective loss function value and a predefined number of iterations is satisfied.

7. The method for training an agent based on transfer training of claim 1, wherein the performing of the deep reinforcement training-based training on the pre-trained target agent in the second environmental condition includes performing repeatedly the deep reinforcement training-based training until a training condition including at least one of a problem solving success rate corresponding to the second environmental condition and a predefined number of iterations is satisfied.

8. A system for training an agent based on transfer training, the system comprising:
a memory storing a program for training an agent pre-trained in a first environmental condition (hereinafter referred to as a source agent) and an agent to be trained (hereinafter referred to as a target agent) based on the source agent in a second environmental condition different from the first environmental condition; and
a processor which, while executing the program stored in the memory, obtains training data for training of the target agent, pre-trains the target agent based on the training data, and then performs deep reinforcement training-based training in the second environmental condition with respect to the pre-trained target agent.

9. The system for training an agent based on transfer training of claim 8, wherein the processor is configured to return a state value including a second observation value for the target agent in addition to a first observation value for a source agent pre-collected with respect to the first environmental condition, and to collect training data for training of the target agent based on an operation result after operating the source agent in the first environmental condition.

10. The system for training an agent based on transfer training of claim 9, wherein the processor is configured to obtain an optimal action value for the first observation value in a policy network, and a value of a current state for the first observation value in a value network, respectively.

11. The system for training an agent based on transfer training of claim 10, wherein the processor is configured to collect an optimal action value and a value for the first observation value and the second observation value as the training data.

12. The system for training an agent based on transfer training of claim 8, wherein the processor is configured to initialize a policy network and a value network of the target agent, then set the training data for training the initialized policy network and the initialized value network based on supervised training, and then perform training by performing repeatedly a process of calculating a loss function of each of the policy network and the value network and updating a weight thereof based on the set training data.

13. The system for training an agent based on transfer training of claim 12, wherein the processor is configured to perform the training repeatedly until a training stopping condition including at least one of a training early stopping condition according to a degree of reduction of the respective loss function value and a predefined number of iterations is satisfied.

14. The system for training an agent based on transfer training of claim 8, wherein the processor is configured to perform repeatedly the deep reinforcement training-based training until a training condition including at least one of a problem solving success rate corresponding to the second environmental condition and a predefined number of iterations is satisfied.
